(19) United States
(12) Patent Application Publication
(10) Pub. No.: US 2025/0135904 A1
(43) Pub. Date: May 1, 2025

(54) METHOD FOR CONVERTING RESERVED AIR CONDITIONING MODE TO START MODE IN ELECTRIC VEHICLE, AND SYSTEM FOR THE SAME

(71) Applicants: Hyundai Motor Company, Seoul (KR); Kia Corporation, Seoul (KR)

(72) Inventors: In Jae Lee, Hwaseong-si (KR); Hyung Gyu Ra, Hwaseong-si (KR)

(21) Appl. No.: 18/915,517

(22) Filed: Oct. 15, 2024

(30) Foreign Application Priority Data
Oct. 26, 2023 (KR) 10-2023-0144661

(51) Int. Cl. B60L 15/20; B60H 1/00; B60R 25/24; B60W 50/00; B60W 50/14

(52) U.S. Cl. CPC B60L 15/20; B60H 1/00742; B60R 25/24; B60W 50/14; B60W 2050/0095; B60W 2050/146; B60W 2510/182

(57) ABSTRACT

An embodiment method for controlling an electric vehicle includes determining whether a function is operated in a reservation mode before a driver gets into the electric vehicle, determining whether the driver getting into the electric vehicle has been completed based on a preset condition, searching for an authentication mechanism inside the electric vehicle, and switching from the reservation mode to a start mode based on the authentication mechanism.

### CROSS-REFERENCE TO RELATED APPLICATIONS

This application claims the benefit of Korean Patent Application No. 10-2023-0144661, filed on Oct. 26, 2023, which application is hereby incorporated herein for all purposes by this reference.

### TECHNICAL FIELD

The present disclosure relates to a method for converting a reserved air conditioning mode to a start mode in an electric vehicle, and a system for the same.

### BACKGROUND

Generally, in summer or winter, the inside of a vehicle is either very hot or very cold right after a driver gets into the vehicle, so even if the driver turns on the engine and turns on the air conditioning or heater as soon as the driver gets into the vehicle, it takes a considerable amount of time to reach a comfortable temperature for driving.

Because of this inconvenience, technologies have been proposed to appropriately control the temperature inside the vehicle by operating the vehicle's air conditioning system before the driver gets into the vehicle. These technologies are called remote/reservation temperature control service (or remote/reserved air conditioning) technology, and the operation process may be performed by a communication terminal that receives the reservation time from the user and notifies a vehicle remote start device of the reservation time and operation time, a vehicle remote start device that transmits the reservation time and operation time notified from the communication terminal to a vehicle remote start ECU of the vehicle, and a vehicle remote start ECU that receives the reservation time and operation time and operates the heater or air conditioner of the vehicle for the operation time until the reservation time is reached.

In addition, the communication terminal is operated to display a temperature range so that the user can determine a temperature range for reservation and select a desired temperature within the temperature range, and when the user does not input the desired temperature, the communication terminal may determine an appropriate target indoor temperature on its own.

The above-mentioned remote air conditioning technology is currently widely applied from internal combustion engine vehicles (including hybrid vehicles) to electric vehicles. When the remote air conditioning work is being performed, the process that the driver gets into the vehicle and starts driving in the internal combustion engine vehicle is different from the corresponding process in the electric vehicle.

With respect to the operation process, in the case of the internal combustion engine vehicle, the engine is already started because the power required to drive the air conditioning system is obtained by driving the internal combustion engine. Therefore, during the remote air conditioning, the driver may get into the vehicle and drive immediately after shifting gears (usually from P mode to D mode).

On the other hand, in the case of electric vehicles, the air conditioning system is driven using a high-voltage relay (IG₃ power supply), so there is no need to drive a power source (usually an engine). Therefore, the start-up operation is not performed. Therefore, in the case of the electric vehicle, driving is possible only when the driver gets into the vehicle during the remote air conditioning and attempts to start the vehicle (by depressing the brake pedal and pressing the start button) and then shifts gears.

As such, since the starting sequence from the driver's getting into the vehicle to driving during the remote air conditioning is different from each other, users who change the vehicle model from an internal combustion engine vehicle to an electric vehicle tend to prefer the starting sequence of the internal combustion vehicle, which has been used previously. And this has become a source of dissatisfaction.

### SUMMARY

Various aspects of embodiments of the present disclosure are directed to solving problems in the art.

An embodiment method for converting a reserved air conditioning mode to a start mode in an electric vehicle and a system for the same allows the starting sequence from a driver getting into a vehicle to driving during remote air conditioning of an electric vehicle to be operated in the same manner as that of a conventional internal combustion engine vehicle, to thereby reduce consumer complaints.

According to an embodiment of the present disclosure, there is provided a method for converting a reserved air conditioning mode to a start mode in an electric vehicle, including determining whether a function is operated in a reservation mode before a driver gets into the vehicle, determining whether the driver's getting into the vehicle has been completed based on a preset condition, searching for an authentication mechanism inside the vehicle, and switching from the reservation mode to a start mode based on the authentication mechanism.

Here, the function may be a remote air conditioning or reserved air conditioning function.

Here, the preset condition may be based on conversion from a door open state to a door closed state of the driver's door. Also, in a system or vehicle of an embodiment of the present disclosure, determining whether the driver's getting into the vehicle has been completed based on the preset condition may include determining that the driver's getting into the vehicle has been completed when all states of the driver's door, a front passenger's door, a rear left passenger's door, or a rear right passenger's door are determined to be door close sates after a door open state of at least one among the driver's door, the front passenger's door, the rear left passenger's door, or the rear right passenger's door has been detected or determined.

Here, the preset condition may be based on a depression of a brake pedal after the door open state of the driver's door.

Here, the switching to the start mode may include determining whether it is allowed for a current vehicle state to be switched to the start mode.

Here, the determining whether it is allowed for a current vehicle state to be switched to the start mode may include determining whether a transmission of the vehicle is in parking mode.

Here, the method may further include requesting the driver to switch to parking mode if it is determined that the transmission is not in parking mode.

Here, the determining whether it is allowed for a current vehicle state to be switched to the start mode may include determining whether a charging connector is connected to a charging terminal of the vehicle.

Here, the method may further include requesting the driver to remove the charging connector if it is determined that the charging connector is connected.

Here, the authentication mechanism may be a smart key or a digital key.

According to an embodiment of the present disclosure, there is provided a system for converting a reserved air conditioning mode to a start mode in an electric vehicle or a vehicle including the same, including a first control unit configured to control electrical elements of the electric vehicle, an air temperature control unit configured to be operated by the first control unit, an authentication module configured to search for an authentication mechanism and perform authentication inside the electric vehicle, and a second control unit configured to receive a signal according to a remote/reserved air conditioning state from the first control unit to determine whether a remote/reserved air conditioning mode is maintained, determine whether a driver's getting into the vehicle has been completed based on a preset condition, and request the first control unit to switch to a start mode based on the authentication mechanism.

Here, in a system or vehicle of an embodiment of the present disclosure, the preset condition may be based on conversion from a door open state to a door closed state of the driver's door. Also, in a system or vehicle of an embodiment of the present disclosure, determining whether the driver's getting into the vehicle has been completed based on the preset condition may include determining that the driver's getting into the vehicle has been completed when all states of the driver's door, a front passenger's door, a rear left passenger's door, or a rear right passenger's door are determined to be door close sates after a door open state of at least one among the driver's door, the front passenger's door, the rear left passenger's door, or the rear right passenger's door has been detected or determined.

Here, in a system or vehicle of an embodiment of the present disclosure, the preset condition may be based on a sensing of a depression of a brake pedal after the door open state of the driver's door.

Here, in a system or vehicle of an embodiment of the present disclosure, the second control unit may determine whether it is allowed for a current state of the electric vehicle to be switched to the start mode if the authentication mechanism is found.

Here, in a system or vehicle of an embodiment of the present disclosure, the determining whether it is allowed for a current state of the electric vehicle to be switched to the start mode may include determining whether a transmission of the vehicle is in parking mode.

Here, in a system or vehicle of an embodiment of the present disclosure, the second control unit may display a message requesting the driver to switch to parking mode if it is determined that the vehicle's transmission is not in parking mode.

Here, in a system or vehicle of an embodiment of the present disclosure, the determining whether it is allowed for a current state of the electric vehicle to be switched to the start mode may include determining whether a charging connector is connected to a charging terminal of the electric vehicle.

Here, in a system or vehicle of an embodiment of the present disclosure, the second control unit may display a message requesting the driver to remove the charging connector if it is determined that the charging connector is connected.

Here, in a system or vehicle of an embodiment of the present disclosure, the authentication mechanism may be a smart key or a digital key.

According to an embodiment of the present disclosure, a method for converting a reserved air conditioning mode to a start mode in an electric vehicle and a system for the same may allow the starting sequence from a driver getting into a vehicle to driving during remote air conditioning of an electric vehicle to be operated in the same manner as that of a conventional internal combustion engine vehicle, to thereby reduce consumer complaints.

### BRIEF DESCRIPTION OF THE DRAWINGS

FIG. 1 is an example of a power system block configuration of an electric vehicle to which a method for converting a reserved air conditioning mode to a start mode according to embodiments of the present disclosure is applied.

FIG. 2 is an example flow diagram for explaining the process of converting a reserved air conditioning mode to a start mode in an electric vehicle according to embodiments of the present disclosure.

It may be understood that the appended drawings are not necessarily to scale, presenting a somewhat simplified representation of various features illustrative of the basic principles of embodiments of the present disclosure. The specific design features of embodiments of the present disclosure as included herein, including, for example, specific dimensions, orientations, locations, and shapes will be determined in part by the particularly intended application and use environment.

In the figures, the same reference numerals refer to the same or equivalent parts of the embodiments of the present disclosure throughout the several figures of the drawings.

### DETAILED DESCRIPTION OF ILLUSTRATIVE EMBODIMENTS

Since various modifications may be applied to exemplary embodiments of the present disclosure and there may be various embodiments, specific embodiments will be illustrated in the drawings and described in the present disclosure. However, this is not intended to limit the present disclosure to specific embodiments and should be understood to include all changes, equivalents, or substitutes included in the spirit and technical scope of the present disclosure.

Suffixes “module” and “part” used herein are only used for the name distinction between components, and they should not be interpreted as having a premise of physicochemical classification or separation.

Terms including ordinal numbers such as “first” and “second” may be used to explain various components, but the components are not limited by the terms. The terms may be used only in a name for distinguishing one component from another component, and the sequence between them is recognized by the context of the description, not by the names.

The term “and/or” is used to include all the cases of any combination of the plural items that are subject to the target. For example, “A and/or B” means all three cases of “A,” “B,” and “A and B.”

When a component is referred to as “connected” or “linked” to another component, it may be directly connected to or linked to that another component, but it should also be understood that there may be a further another component therebetween.

The terms used in the present disclosure are used to explain particular embodiments, and they are not intended to limit the present disclosure. A singular term in the present disclosure includes a plural term unless it contextually and clearly means a singular form. In the present disclosure, the terms such as “include” or “have” are to specify that there are features, numbers, steps, operations, components, or parts described in the present disclosure, or combinations thereof, and it should be understood that the presence or the possibility of addition of numbers, steps, operations, components, parts, or combinations thereof are not excluded in advance.

Unless defined differently, all the terms used here, including technical or scientific terms, have the same meaning as commonly understood by those who have normal knowledge in the technical field to which the present disclosure belongs. Terms such as what are commonly used in the dictionary should be interpreted as having the meaning of the context of the relevant technology, and they are not to be interpreted as having an ideal or excessively formal meaning unless defined clearly in the present disclosure.

In addition, “unit,” “control unit,” “control device,” or “controller” is a term widely used as a name of a device that controls its function, and it does not mean a general function unit. For example, a device, which uses one of the above names, may include a communication device which communicates with another controller or sensor for control of the function, a recording medium which may be read by a computer that stores an operating system, a logic command, and input and output information, etc., and one or more processors which perform judgment, operations, and decisions required for the function control.

Further, a processor may include a semiconductor integrated circuit and/or electronic devices that perform at least one or more of comparison, judgment, operation, and decision to achieve a programmed function. For example, the processor may be any one or a combination of a computer, a micro processor, a CPU, an ASIC, and an electronic circuit (circuitry, logic circuits).

In addition, a recording medium readable by a computer (or briefly called a memory) includes all kinds of storage devices that may be read by a computer system. For example, the storage medium may include at least one of a flash memory, a hard disk type memory, a micro type memory, a card type memory, a secure digital (SD) card, an extreme digital (XD) card, a random access memory (RAM), a static RAM, a read-only memory (ROM), a programmable ROM (PROM), an electrically erasable PROM (EEPROM), a magnetic RAM (MRAM), a magnetic disk type memory, and an optical disk type memory.

Such a recording medium may be electrically connected to a processor, and the processor may load and record data from the recording medium. A recording medium and a processor may be integrated or physically separated.

Hereinafter, with reference to the attached drawings, a method for converting a reserved air conditioning mode to a start mode in an electric vehicle and a system for the same according to embodiments of the present disclosure will be described as follows with reference to the attached drawings. In exemplary embodiments, the start mode may be an ‘EV Ready’ mode of the start button of the electric vehicle. As the vehicle enters into the EV Ready mode, electric power is applied to at least the electric elements necessary for driving the vehicle. In an exemplary embodiment, in the EV Ready mode, the power is applied to all of the electric elements in the vehicle. In the EV Ready mode, as the brake pedal is released or the acceleration pedal is depressed, the vehicle advances.

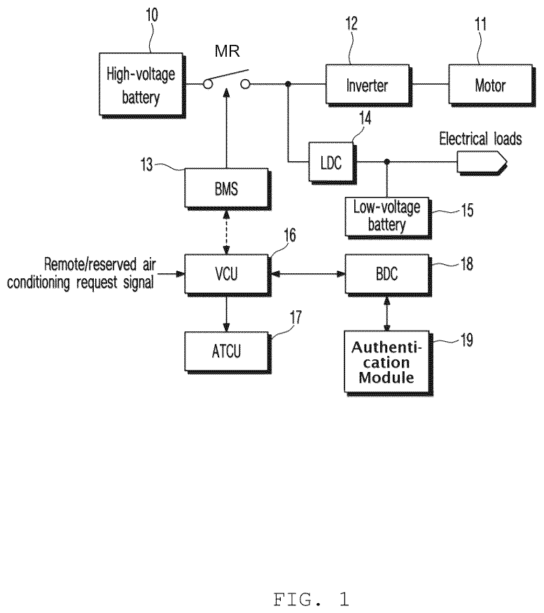

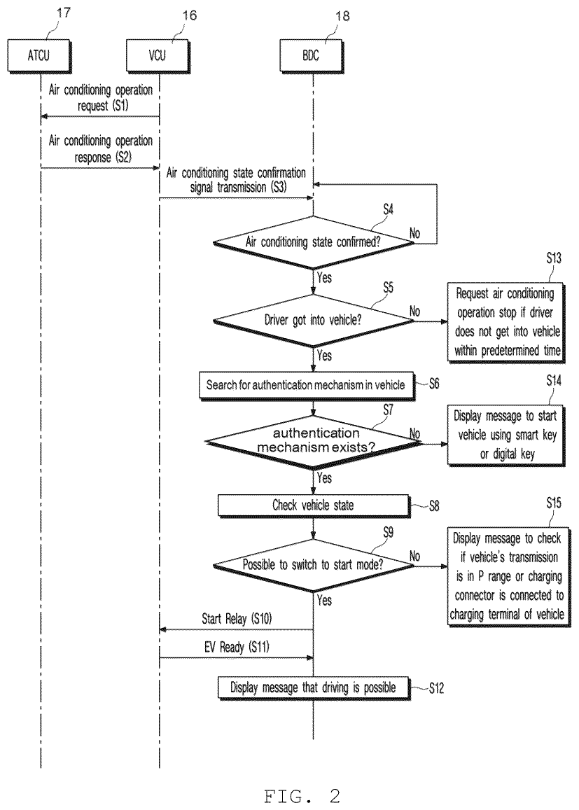

FIG. 1 is an example of a power system block configuration of an electric vehicle to which a method for converting a reserved air conditioning mode to a start mode according to embodiments of the present disclosure is applied, and FIG. 2 is an example flow diagram for explaining the process of converting a reserved air conditioning mode to a start mode in an electric vehicle according to embodiments of the present disclosure.

As shown in FIG. 1, the basic power system block configuration of an electric vehicle to which embodiments of the present disclosure is applied may include a motor 11, an inverter 12 configured to drive the motor 11, a high-voltage battery 10 as a power source for operating the motor 11, a main relay MR configured to open and close the power supply path between the high-voltage battery 10 and the inverter 12 according to a control signal, a low-voltage battery 15 with a lower voltage than the high-voltage battery 10, a low-voltage DC-DC converter (LDC) 14 configured to decompress the high-voltage power of the high-voltage battery 10 and supply the decompressed power to the low-voltage battery 15, and a battery management system (BMS) 13 configured to control the main relay MR on/off.

In addition to the basic power system of an electric vehicle as described above, a vehicle control unit (VCU) is used as a control unit 16 for controlling electrical elements that constitute the electric vehicle.

The main components of the system, to which the method for converting a reserved air conditioning mode to a start mode in an electric vehicle is applied, may include an air temperature control unit (ATCU) 17 operated by the control unit 16, an authentication module 19 configured to search for an authentication mechanism such as a smart key or a digital key to determine whether such an authentication mechanism exists and perform authentication, and a body domain controller (BDC) 18 configured to receive a control signal according to the remote/reserved air conditioning state from the control unit 16, recognize the on/off state of a door in relation to the body of the vehicle, the transmission state, and the connection state of a charging terminal through which external power flows in, and request conversion to the start mode to the control unit 16 if preset conditions are satisfied by performing authentication according to the driver's getting into the vehicle through the authentication module 19.

At this time, the module may be implemented as a memory which stores a program for performing the corresponding function and a processor which executes the program, and the memory of each of the modules may be integrated into one or more memories, and each processor may be integrated into one or more processors.

Based on the power system block configuration of an electric vehicle to which embodiments of the present disclosure is applied configured as described above, the process of converting a reserved air conditioning mode to a start mode in an electric vehicle according to embodiments of the present disclosure will be described below with reference to FIG. 2.

When the user requests to operate the ATCU 17 remotely or in reserved air conditioning mode in the VCU 16, the air conditioning operation is requested to the ATCU 17 through step S1.

Accordingly, the ATCU 17 operates according to the air conditioning request in step S1 and responds to the VCU 16 through step S2 that the air conditioning process is currently in progress.

When the VCU 16 confirms that the air conditioning process is currently in progress through step S2, the process proceeds to step S3 and the VCU 16 transmits a signal confirming that the air conditioning is in operation to the BDC 18.

Here, an example of a signal transmitted from the VCU 16 through step S3 is “VCU_AirconCtrReq@VCU_04_100ms_3=Active(ox1).”

Thereafter, the BDC 18 determines whether the remote/reserved air conditioning mode is maintained through step S4. That is, if it is determined that the signal transmitted from the VCU 16 is Active(ox1) through step S3, the process proceeds to step S5 to determine whether the driver's getting into the vehicle has been completed based on the preset conditions.

At this time, the preset condition refers to the conversion from the door open state to the door closed state of the driver's door or detecting the depression of the brake pedal after the door open state of the driver's door.

In other words, it is determined whether the driver has actually gotten into the vehicle.

In addition, the process of step S5 is usually performed for a preset time of about 30 minutes. If it is determined that the driver has not gotten into the vehicle for 30 minutes, the process proceeds to step S13 to request the VCU 16 to stop the ATCU 17.

If it is determined in step S5 that the driver got into the vehicle, the process proceeds to step S6 and the BDC 18 searches for an authentication mechanism to determine whether an authentication mechanism exists inside the vehicle through the authentication module 19.

Here, the authentication mechanism refers to a smart key or a digital key, but it is not limited thereto.

The BDC 18 determines whether the authentication mechanism exists inside the vehicle through the authentication module 19 in step S7. If the above-mentioned authentication mechanism is not found, it is determined that the user is not a legitimate user and the process proceeds to step S14. In step S14, a message to start the engine using a smart key or a digital key is displayed, and the operation process according to embodiments of the present disclosure is terminated.

On the other hand, if it is determined in step S7 that the authentication mechanism exists inside the vehicle through the authentication module 19, the process proceeds to step S8 and the current status of the vehicle is checked.

Thereafter, in step S9, it is determined whether the vehicle can be started in the current state of the vehicle checked in step S8. In other words, it is determined whether the vehicle's transmission is in parking mode (P range) or whether the charging connector is connected to the vehicle's charging terminal.

In the process of step S9, if the vehicle's transmission is not in parking mode (P range) or the charging connector is connected to the charging terminal of the vehicle, an accident may occur when the vehicle is started and driven. Hence, the driver is asked to change the vehicle's transmission to parking mode (P range) or remove the external charging connector from the charging terminal through step S15.

If it is determined that the conversion to the start mode of the vehicle is possible in the process of step S9 described above, the BDC 18 transmits a Start Relay request signal to the VCU 16 by proceeding to step S10, and the VCU 16 completes the conversion to start mode through the process of transmitting an EV Ready signal to the BDC 18 through step S11.

Accordingly, the BDC 18 displays a notice to the driver that driving is currently possible through step S12.

Therefore, when getting into the vehicle with an authentication mechanism during remote/reserved air conditioning, the driver can conveniently start driving through a simpler departure sequence than before.

In the above, preferred embodiments of the present disclosure have been illustrated and described, but the present disclosure is not limited to the specific embodiments described above, and various modifications and implementations can be made by those skilled in the art without departing from the gist of the present disclosure as claimed in the patent claims. And these modified implementations should not be understood individually from the technical idea or perspective of the present disclosure.

What is claimed is:

1. A method for controlling an electric vehicle, the method comprising:
determining whether a function is operated in a reservation mode before a driver gets into the electric vehicle;
determining whether the driver getting into the electric vehicle has been completed based on a preset condition;
searching for an authentication mechanism inside the electric vehicle; and
switching from the reservation mode to a start mode based on the authentication mechanism.

2. The method of claim 1, wherein the function comprises a remote air conditioning function or a reserved air conditioning function.

3. The method of claim 1, wherein the preset condition is based on conversion from a door open state of at least one among a driver's door, a front passenger's door, a rear left passenger's door, or a rear right passenger's door to door closed states of all the doors.

4. The method of claim 1, wherein the preset condition is based on a depression of a brake pedal after a door open state of a driver's door.

5. The method of claim 1, wherein switching from the reservation mode to the start mode comprises determining whether it is allowed for a current vehicle state to be switched to the start mode.

6. The method of claim 5, wherein determining whether it is allowed for the current vehicle state to be switched to the start mode comprises determining whether a transmission of the electric vehicle is in parking mode.

7. The method of claim 6, further comprising requesting the driver to switch to the parking mode based on a determination that the transmission is not in the parking mode.

8. The method of claim 5, wherein determining whether it is allowed for the current vehicle state to be switched to the start mode comprises determining whether a charging connector is connected to a charging terminal of the electric vehicle.

9. The method of claim 8, further comprising requesting the driver to remove the charging connector based on a determination that the charging connector is connected.

10. The method of claim 1, wherein the authentication mechanism comprises a smart key or a digital key.

11. A system for controlling an electric vehicle, the system comprising:
an electronics controller configured to control electrical elements of the electric vehicle;
an air temperature controller configured to be operated by the electronics controller;
an authentication module configured to search for an authentication mechanism inside the electric vehicle and perform authentication; and
a second controller configured to receive a signal according to a remote/reserved air conditioning state from the electronics controller to determine whether a remote/reserved air conditioning mode is maintained, determine whether getting into the electric vehicle by a driver has been completed based on a preset condition, and request the electronics controller to switch to a start mode based on the authentication mechanism.

12. The system of claim 11, wherein the preset condition is based on conversion from a door open state of at least one among a driver's door, a front passenger's door, a rear left passenger's door, or a rear right passenger's door to door closed states of all the doors.

13. The system of claim 11, wherein the preset condition is based on a sensing of a depression of a brake pedal after a door open state of a driver's door.

14. The system of claim 11, wherein the second controller is further configured to determine whether it is allowed for a current state of the electric vehicle to be switched to the start mode based on the authentication mechanism.

15. The system of claim 14, wherein the second controller is further configured to determine whether it is allowed for the current state of the electric vehicle to be switched to the start mode by determining whether a transmission of the electric vehicle is in a parking mode.

16. The system of claim 15, wherein the second controller is further configured to display a message requesting the driver to switch to the parking mode in response to a determination that the transmission is not in the parking mode.

17. The system of claim 14, wherein the second controller is further configured to determine whether it is allowed for the current state of the electric vehicle to be switched to the start mode by determining whether a charging connector is connected to a charging terminal of the electric vehicle.

18. The system of claim 17, wherein the second controller is further configured to display a message requesting the driver to remove the charging connector in response to a determination that the charging connector is connected.

19. The system of claim 11, wherein the authentication mechanism comprises a smart key or a digital key.

20. An electric vehicle comprising:
an electronics controller configured to control electrical elements of the electric vehicle;
an air temperature controller configured to be operated by the electronics controller;
an authentication module configured to search for an authentication mechanism inside the electric vehicle and perform authentication; and
a second controller configured to receive a signal according to a remote/reserved air conditioning state from the electronics controller to determine whether a remote/reserved air conditioning mode is maintained, determine whether a driver's getting into the electric vehicle has been completed based on a preset condition, and request the electronics controller to switch to a start mode based on the authentication mechanism.
